(19) United States
(12) Patent Application Publication
(10) Pub. No.: US 2016/0078524 A1
(43) Pub. Date: Mar. 17, 2016

(54) METHOD AND SYSTEM FOR SUGGESTING AND PROCESSING REGULAR TRANSACTIONS BASED ON PRODUCT DATA

(71) Applicant: MasterCard International Incorporated, Purchase, NY (US)

(72) Inventors: Randall K. SHUKEN, Westport, CT (US); Debashis GHOSH, Charlotte, NC (US)

(73) Assignee: MASTERCARD INTERNATIONAL INCORPORATED, Purchase, NY (US)

(21) Appl. No.: 14/486,415

(22) Filed: Sep. 15, 2014

(51) Int. Cl. G06Q 30/06; G06Q 20/32; G06Q 20/40

(52) U.S. Cl. CPC G06Q 30/0637; G06Q 20/40; G06Q 20/3224

(57) ABSTRACT

A method for identifying and initiating a regular transaction for a consumer includes: storing a merchant profile, the profile including data related to a merchant including a merchant geolocation; storing an account profile, the profile including data related to a consumer including a plurality of transaction data entries, each including data related to a transaction involving the consumer including a set of one or more product identifiers corresponding to products purchased in the transaction; identifying a regular order for the consumer, the regular order including a specific set of one or more product identifiers based on frequency of the specific set as the set included in the transaction data entries in the account profile; receiving a geolocation associated with the consumer, the geolocation being within a predetermined distance of the geolocation in the merchant profile; and transmitting at least the one or more product identifiers included in the specific set.

### FIELD

The present disclosure relates to the identification and initiation of a regular transaction, specifically the use of historical product purchase data to identify a regular transaction for a consumer and initiation of the transaction at a merchant upon arrival at the merchant.

### BACKGROUND

Consumers that frequent a merchant are often referred to as “regulars” at that merchant. In many instances, employees of the merchant will recognize the consumer as a regular consumer, which may build a strong relationship between consumer and merchant. The result is that the consumer may feel more welcome at the merchant and may receive better service, and the merchant may have a reliable source of revenue in their regular consumer.

For many consumers, an advantage of being known at a merchant as a regular is that employees of the merchant may recognize them and immediately begin working on their order. For instance, if the merchant is a coffee shop, an employee may see the regular consumer enter the shop and start making their usual coffee so that it will be ready faster. The transaction may thus be completed faster, which may benefit both parties, and may help reinforce to the consumer that the merchant highly values their patronage.

In order to provide a consumer with their regular purchase, many merchants rely on memory of the employees themselves in recognizing a regular consumer and remembering their regular order to provide such a benefit. Other merchants may use loyalty systems, such as reading a consumer's loyalty card, which may identify the consumer in their point of sale system, which may store a saved, regular order. However, such systems, when they are available, often require the merchant or consumer to enter in the consumer's order to be saved, and may therefore be ineffective unless a consumer or merchant is actively aware of a consumer's regular order, and may have to be actively changed if the consumer's regular order changes. In addition, the consumer's regular order may be only available at that particular merchant, with other merchants unaware of their preferences.

Thus, there is a need for a technical solution for providing a system for identifying and initiating a regular transaction for a consumer at a merchant based on purchase history for the consumer at that merchant or similar merchants.

### SUMMARY

The present disclosure provides a description of systems and methods for identifying and initiating a regular transaction for a consumer.

A method for identifying and initiating a regular transaction for a consumer includes: storing, in a merchant database, a merchant profile, wherein the merchant profile includes data related to a merchant including at least a merchant geolocation; storing, in an account database, an account profile, wherein the account profile includes data related to a consumer including at least a plurality of transaction data entries, each transaction data entry including data related to a payment transaction involving the related consumer and a merchant including at least a set of one or more product identifiers corresponding to products purchased in the related payment transaction; identifying, by a processing device, a regular order for the consumer, wherein the regular order includes a specific set of one or more product identifiers based on frequency of the specific set of one or more product identifiers as the set of one or more product identifiers included in the plurality of transaction data entries stored in the account profile; receiving, by a receiving device, a geolocation associated with the consumer, wherein the geolocation is within a predetermined distance of the merchant geolocation included in the merchant profile; and transmitting, by a transmitting device, at least the one or more product identifiers included in the specific set.

A system for identifying and initiating a regular transaction for a consumer includes a merchant database, an account database, a processing device, a receiving device, and a transmitting device. The merchant database is configured to store a merchant profile, wherein the merchant profile includes data related to a merchant including at least a merchant geolocation. The account database is configured to store an account profile, wherein the account profile includes data related to a consumer including at least a plurality of transaction data entries, each transaction data entry including data related to a payment transaction involving the related consumer and a merchant including at least a set of one or more product identifiers corresponding to products purchased in the related payment transaction. The processing device is configured to identify a regular order for the consumer, wherein the regular order includes a specific set of one or more product identifiers based on frequency of the specific set of one or more product identifiers as the set of one or more product identifiers included in the plurality of transaction data entries stored in the account profile. The receiving device is configured to receive a geolocation associated with the consumer, wherein the geolocation is within a predetermined distance of the merchant geolocation included in the merchant profile. The transmitting device is configured to transmit at least the one or more product identifiers included in the specific set.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the identification and initiation of a regular transaction for a consumer in accordance with exemplary embodiments.

FIG. 2 is a block diagram illustrating the processing server of FIG. 1 for the identification of a consumer's regular transaction and initiation thereof in accordance with exemplary embodiments.

FIG. 3 is a flow diagram illustrating a process for the initiation of a regular transaction for a consumer at a merchant using the system of FIG. 1 in accordance with exemplary embodiments.

FIG. 4 is a flow diagram illustrating a process for the identification and initiation of a regular transaction for a consumer using the processing server of FIG. 2 in accordance with exemplary embodiments.

FIG. 5 is a diagram illustrating the identification of a regular transaction based on purchase data in accordance with exemplary embodiments.

FIG. 6 is a flow chart illustrating an exemplary method for identifying and initiating a regular transaction for a consumer in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

### System for Identifying and Initiating Regular Transactions

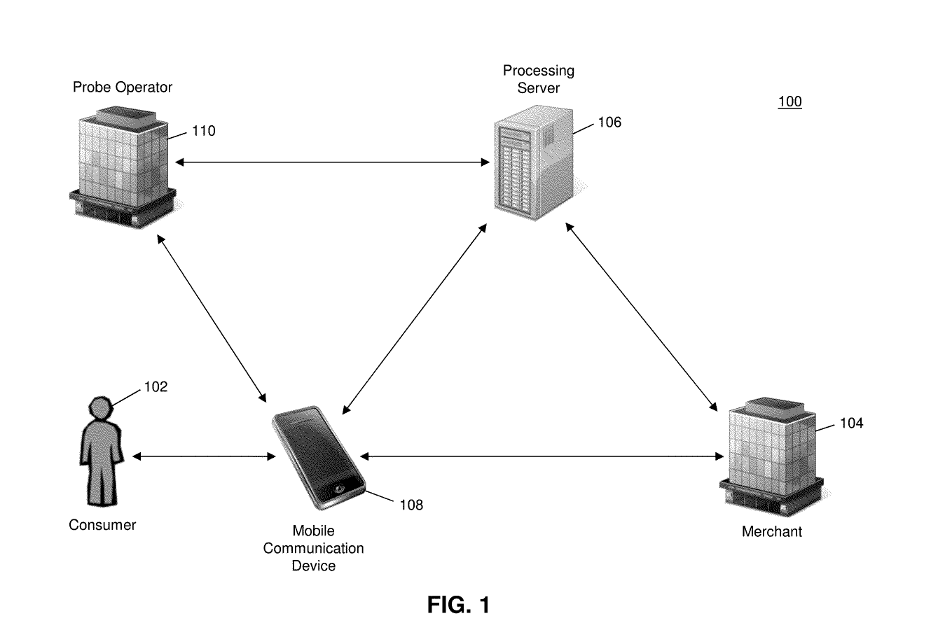

FIG. 1 illustrates a system 100 for the identification and initiation of regular transactions for a consumer based on consumer purchase data.

A consumer 102 may conduct payment transactions at a merchant 104. The payment transactions may be for the purchase of products (e.g., goods and/or services) from the merchant 104. Product data, such as product identifiers, may be captured for the products purchased in the transactions conducted between the consumer 102 and the merchant 104. As part of the conducting of the payment transactions, transaction details for each transaction, including the product data, may be captured and transmitted to a processing server 106. In some instances, the transaction details may be transmitted to the processing server 106 by a payment network configured to process the payment transactions. In other instances, the processing server 106 may be part of the payment network and may, in further instances, be configured to process the payment transactions.

The processing server 106, discussed in more detail below, may be configured to identify a regular transaction for the consumer 102 based on the received transaction data. The processing server 106 may analyze the product data included in transactions involving the consumer 102 to identify one or more products that are regularly purchased by the consumer 102 at the merchant 104. For example, if the merchant 104 is a coffee shop, the processing server 106 may identify that the consumer 102 regularly purchases a large cappuccino. In some embodiments, a regular transaction may be identified based on frequency in comparison to other transactions, frequency over time, merchant industry, etc.

Once a regular transaction is identified, the processing server 106 may be configured to assist the consumer 102 with their regular order when they visit the merchant 104. For instance, in one embodiment, the processing server 106 may transmit a request to a mobile communication device 108 associated with the consumer 102 to request if the consumer 102 desires their regular order when they approach or enter the merchant 104. For example, the consumer 102 may receive a short message service (SMS) message on the mobile communication device 108 asking if they would like their usual large cappuccino as they enter the merchant 104. The mobile communication device 108 may be any type of mobile device suitable for performing the functions disclosed herein, such as a cellular phone, smart phone, smart watch, personal digital assistance, tablet computer, notebook computer, laptop computer, etc.

The processing server 106 may then transmit a notification to the merchant 104 that the consumer 102 is at the store and wants their regular order of a large cappuccino. The order may then be entered into the point of sale system at the merchant 104 and may be prepared, without the consumer 102 having to initiate the transaction. In some instances, the merchant point of sale system may be configured to enter the transaction automatically upon receipt of the notification from the processing server 106. In such an instance, the consumer's 102 regular order may be prepared automatically upon confirmation, without additional steps being required by the merchant 104 or any employees. Such a process may improve the speed at which the consumer's 102 order may be prepared, delivered, and paid for.

In some embodiments, the processing server 106 may be configured to transmit payment details for a transaction for the regular order to the merchant 104 for use in conducting a payment transaction for the order. In one such embodiment, the consumer 102 may provide payment details as part of their confirmation to the processing server 106 (e.g., via the mobile communication device 108). In another embodiment, the processing server 106 may store payment details for one or more payment methods, and may transmit the payment details to the merchant 104, with a method being preferred by the consumer 102 and/or indicated in the notification. In yet another embodiment, the merchant 104 may have the consumer's 102 payment details on file for use for the regular order. In any such embodiment, the transaction may be initiated, processed, and paid for, all upon confirmation by the consumer 102 upon arriving at the merchant 104, which may greatly increase the speed and efficiency of the consumer's 102 transaction, as well as the merchant's 104 transactions as a whole.

In some instances, a regular transaction for the consumer 102 may be limited by time and/or date. For example, the consumer 102 may have a regular transaction for a large cappuccino at a coffee shop only between the hours of 6 A.M. and 9 A.M. based on their transaction history as analyzed by the processing server 106. In a further example, the large cappuccino may be the consumer's 102 regular order during those hours only on weekdays and not on the weekend. In some embodiments, a consumer 102 may have multiple regular orders, which may be based on one or more time and/or date criteria. For example, the consumer 102 may have a regular order at a coffee shop of a large cappuccino on weekdays between 6 A.M. and 9 A.M., but may have a regular order of a medium latte on the weekends.

In some instances, the processing server 106 may be configured to initiate a transaction for a regular order across multiple merchants, such as based on the merchant industry. For example, the processing server 106 may identify that the consumer 102 regularly orders a large cappuccino at one or more coffee shops. When the consumer 102 visits a different coffee shop, such as one that they have never visited, the processing server 106 may identify that the consumer 102 is at a coffee shop and that the consumer regularly orders their large cappuccino at coffee shops, and may request confirmation from the consumer 102 to initiate their regular order, and may transmit the order to the new coffee shop for initiation. In such an example, a merchant 104 that has no prior relationship with a consumer 102 may still be able to provide the consumer's 102 regular order due to similarity in products and/or menu.

In further embodiments, the processing server 106 may be configured to suggest products similar to a regular order based on associations, information provided by merchants 104, and other suitable criteria that will be apparent to persons having skill in the relevant art. For example, the consumer 102 may have a regular order of a specific type of cheeseburger at a specific merchant 104. When the consumer 102 visits a different merchant 104, the processing server 106 may request confirmation of a regular transaction for a similar type of cheeseburger, such as a menu item by the different merchant 104 that has the same or similar options, as may be identified by the processing server 106 or different merchant 104. In such an embodiment, the processing server 106 may be able to provide the consumer 102 with their similar regular experience at a new merchant 104.

The system 100 may also include a probe operator 110. The probe operator 110 may be an entity configured to identify the geographic location of the mobile communication device 108 associated with the consumer 102. The geographic location of the mobile communication device 108 may be identified using methods and systems that will be apparent to persons having skill in the relevant art. The probe operator 110 may identify the geographic location of the mobile communication device 108 and transmit the location to the processing server 106. The processing server 106 may then use the geographic location to identify a merchant 104 being visited by the consumer 102 in order to identify if a regular transaction exists for the merchant 104 or a merchant industry of the merchant 104.

Using the methods and systems discussed herein, the processing server 106 may provide for automatic identification of a regular transaction for a consumer 102 at a particular merchant 104 and/or within a merchant industry, which may improve the consumer experience at a merchant 104 and may thereby result in increased revenue at merchants 104 as well. Furthermore, by the processing server 106 automatically identifying regular transactions, the transactions may be identified and initiated with minimal interaction by the consumer 102 and merchant 104.

In addition, the processing server 106 may be configured to easily update or remove a consumer's 102 regular transaction. For example, the processing server 106 may regularly analyze the consumer's 102 purchase history to determine if a regular transaction is no longer regular, or if a different transaction has achieved a higher frequency, and may update or remove their regular transaction accordingly. In another example, if the consumer 102 denies confirmation of a regular transaction a predetermined number of times (e.g., three in a row), the processing server 106 may ask the consumer 102 if they would like to delete the order as being their regular transaction. Such additional features may enable the processing server 106 to provide for an even more effective and efficient consumer experience to the benefit of the consumer 102 and merchants 104.

### Processing Server

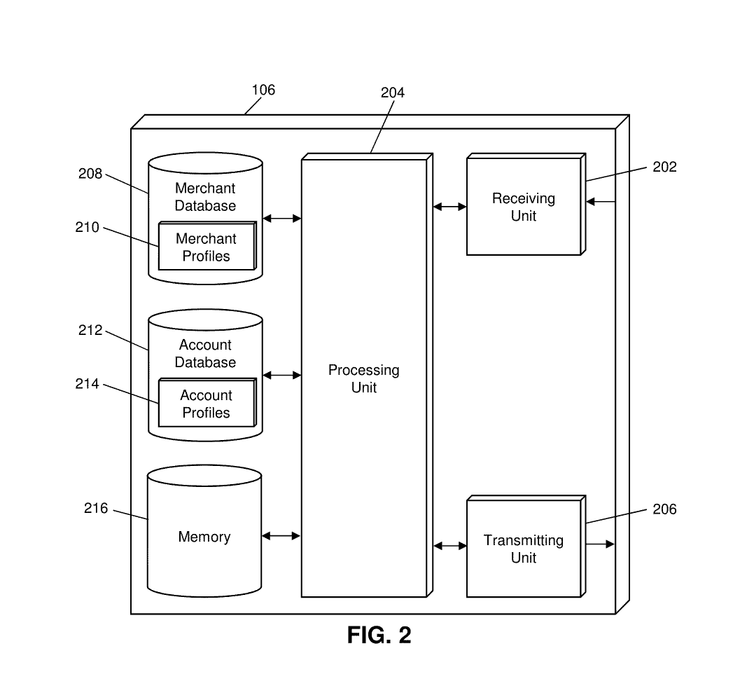

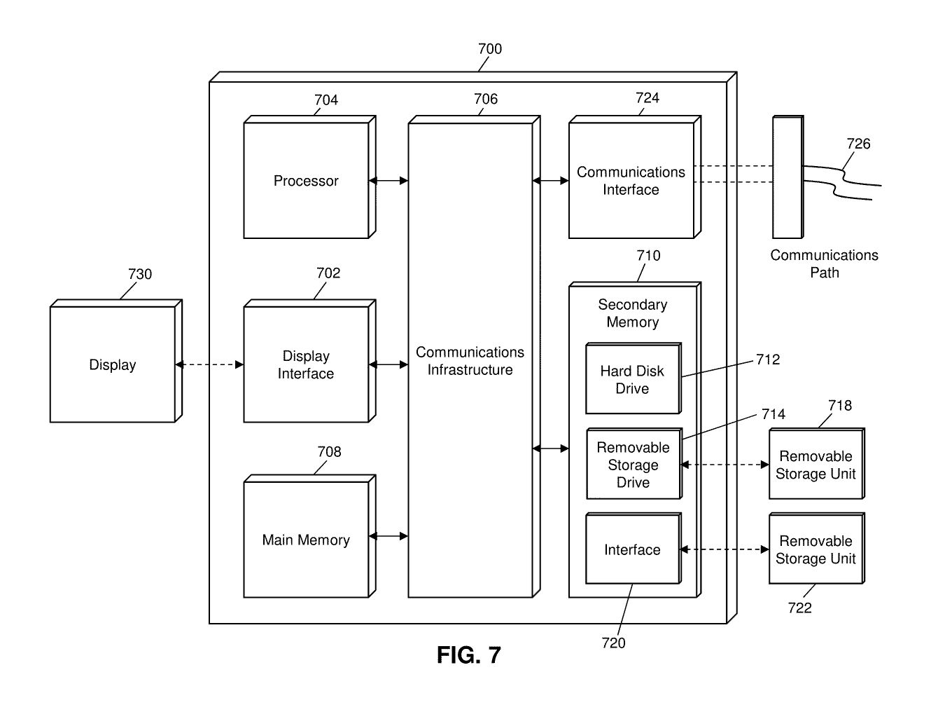

FIG. 2 illustrates an embodiment of the processing server 106 of the system 100. It will be apparent to persons having skill in the relevant art that the embodiment of the processing server 106 illustrated in FIG. 2 is provided as illustration only and may not be exhaustive to all possible configurations of the processing server 106 suitable for performing the functions as discussed herein. For example, the computer system 700 illustrated in FIG. 7 and discussed in more detail below may be a suitable configuration of the processing server 106.

The processing server 106 may include a receiving unit 202. The receiving unit 202 may be configured to receive data over one or more networks via one or more network protocols. The receiving unit 202 may receive transaction data for payment transactions involving the consumer 102 and one or more merchants 104. The transaction data may be received from a payment network configured to process the respective payment transaction or may be received by the receiving unit 202 during processing of a payment transaction by the processing server 106, such as from a merchant 104 or acquiring financial institution. The receiving unit 202 may also receive geographic locations of a mobile communication device 108 associated with the consumer 102 from the probe operator 110.

The processing server 106 may also include a merchant database 208. The merchant database 208 may include one or more merchant profiles 210. Each merchant profile 210 may be configured to store data related to a merchant 104 including at least a geolocation associated with the related merchant 104. The geolocation may be a physical location or locations of the related merchant 104 and may be represented by latitude and longitude, street address, postal code, zip code, or any other suitable type of geographic representation.

The processing server 106 may also include an account database 212. The account database 212 may include one or more account profiles 214. Each account profile 214 may include data related to a consumer 102 including at least a plurality of transaction data entries. Each transaction data entry may include data related to a payment transaction involving the related consumer 102 and a merchant 104 and may include at least a set of one or more product identifiers corresponding to products purchased in the related payment transaction. A product identifier may be a value suitable for identification of the associated product, such as a unique value (e.g., a universal product code, serial number, stock-keeping unit, identification number, etc.), name, description, etc.

The processing server 106 may also include a processing unit 204. The processing unit 204 may be configured to perform the functions of the processing server 106 discussed herein as will be apparent to persons having skill in the relevant art. The processing server 106 may be configured to identify one or more regular orders for an account profile 214 based on the sets of product identifiers included in each of the transaction data entries in the account profile 214. A regular order may be identified based on a frequency of a set of one or more product identifiers, and may be further based on a transaction time and/or date, and/or other criteria, also included in the transaction data entries of the account profile 214. An identified regular order may be for the products associated with the product identifiers included in the respective set of one or more product identifiers. In some instances, the processing unit 204 may identify multiple regular orders for an account profile 214, such as based on variances in time and/or date.

The processing unit 204 may be further configured to identify when the consumer 102 arrives at a merchant 104. The identification may be based on a geographic location received by the receiving unit 202. When a geographic location is received, the processing unit 204 may identify if the geolocation included in a merchant profile 210 is included in or encompasses the received geographic location. Once a merchant profile 210 is identified, the processing unit 204 may identify if a regular transaction exists for the consumer 102 at the related merchant 104 or for a merchant industry associated with the related merchant 104, and, if applicable, for the current time and/or date.

The processing server 106 may further include a transmitting unit 206. The transmitting unit 206 may be configured to transmit data over one or more networks via one or more network protocols. The transmitting unit 206 may transmit a message to the mobile communication device 108 (e.g., an SMS message, multimedia service message, e-mail message, etc.) requesting If the consumer 102 desires their regular order. The receiving unit 202 may receive a confirmation or denial in response to the request. If the regular order is confirmed, the transmitting unit 206 may transmit a message to the merchant 104 related to the identified merchant profile 210 informing the merchant 104 of the consumer 102 arriving and their regular order. In some embodiments, payment details may be included in the transmitted message.

The processing server 106 may also include a memory 216. The memory 216 may be configured to store data suitable for performing the functions disclosed herein. For example, the memory 216 may include merchant industry rules or settings, product association data, notification data, etc., and additional data that will be apparent to persons having skill in the relevant art.

It will be further apparent to persons having skill in the relevant art that the processing server 106 may include additional components, and/or the components of the processing server 106 illustrated in FIG. 2 and discussed herein may be configured to perform additional functions. For example, the components of the processing server 106 may be further configured to perform the functions of a payment network, such as in embodiments where the processing server 106 may receive authorization requests from merchants 104 for processing, and the corresponding transaction data identified and stored in the account profiles 214 for use in the methods discussed herein.

### Process for Identifying and Initiating a Regular Transaction

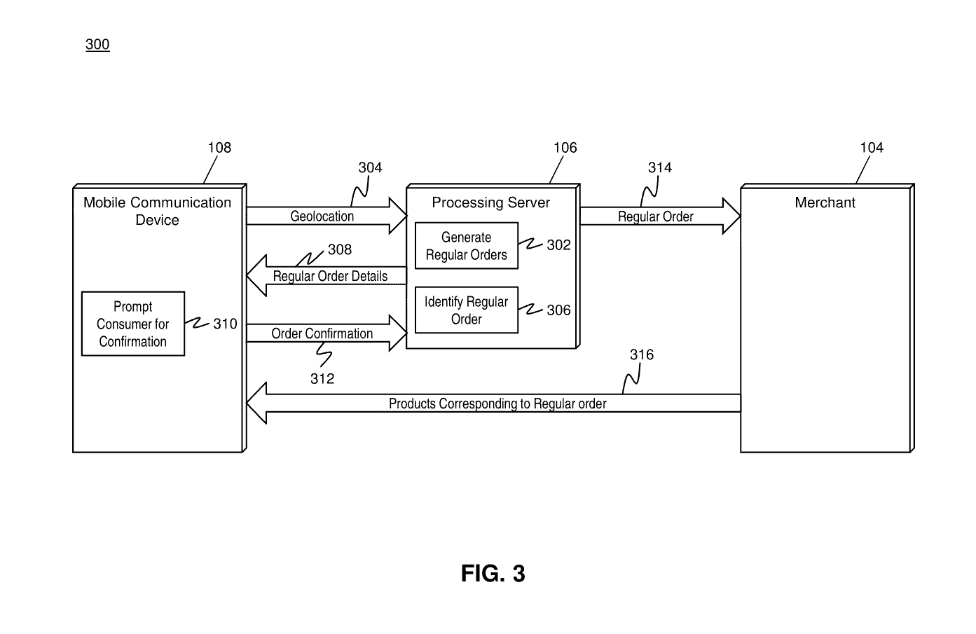

FIG. 3 illustrates a process 300 for the identification and initiation of a regular transaction using the system 100.

In step 302, the processing unit 204 of the processing server 106 may identify an account profile 214 for the consumer 102 and may identify one or more regular orders for the consumer 102 based on the product identifiers included in the transaction data entries included in the account profile 214. In some instances, the regular orders may be specific to a merchant and/or merchant industry, time and/or date, etc. In step 304, the mobile communication device 108 may report its geolocation to the processing server 106, which may be received by the receiving unit 202 of the processing server 106. In some embodiments, the geolocation may first be identified by the probe operator 110 and then transmitted to the processing server 106.

In step 306, the processing unit 204 may identify a merchant profile 210 that includes a geolocation that includes or is encompassed by the geolocation of the mobile communication device 108, and may then identify a regular order for the consumer 102 that corresponds to the related merchant 104 or merchant industry for the merchant profile 210. In instances where the regular order may be specific to a time and/or date, the processing unit 204 may first identify the current time and/or date and identify a regular order accordingly.

In step 308, the transmitting unit 206 of the processing server 106 may transmit order details for the regular order to the mobile communication device 108. In step 310, the mobile communication device 108 may display the order details to the consumer 102 and prompt the consumer 102 to confirm that they would like their regular order. The consumer 102 may input their confirmation into the mobile communication device 108 which may then, in step 312, transmit an order confirmation to the processing server 106.

The order confirmation may be received by the receiving unit 202. In step 314, the transmitting unit 206 may transmit the order details for the consumer's 102 regular order to the merchant 104 related to the earlier identified merchant profile 210. In some embodiments, the order details may include and/or may be accompanied by payment details, such as stored in an account profile 214 associated with the consumer 102 and/or identified in the order confirmation received in step 312. Once the order has been received, in step 316, the merchant 104 may process a transaction for the regular order and may provide the consumer 102 with the products corresponding to their regular order.

### Identification of a Regular Transaction

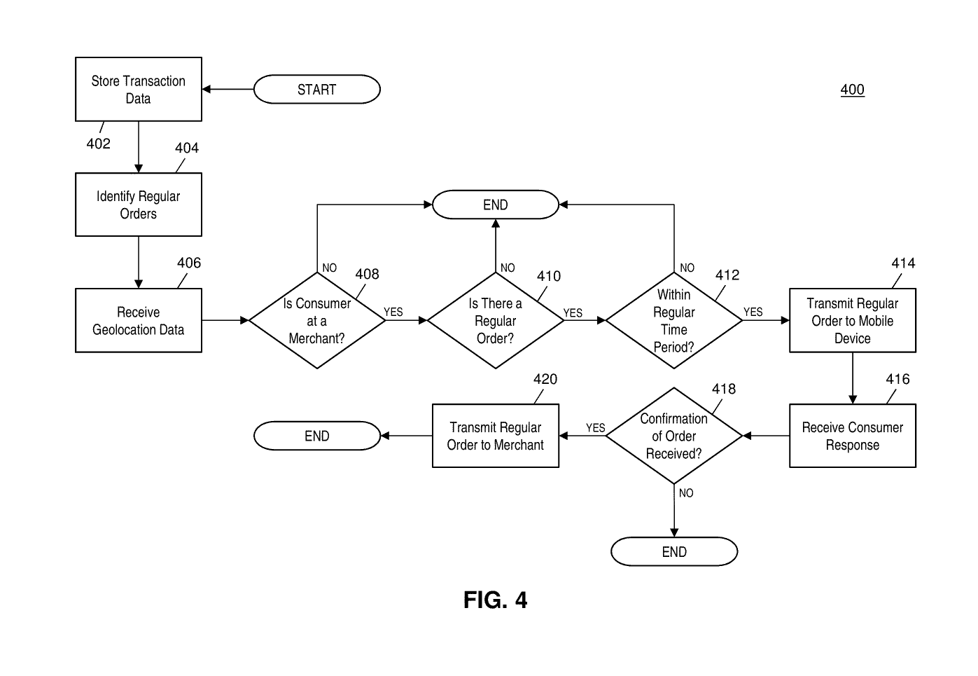

FIG. 4 illustrates a process 400 for the identification of a regular transaction using the processing server 106 of the system 100 and illustrated in FIG. 2 and discussed above, as well as the initiation of a payment transaction for the identified regular order.

In step 402, the processing server 106 may store transaction data for a plurality of payment transactions involving the consumer 102 in an account profile 214 related to the consumer 102 in the account database 212. A transaction data entry for each payment transaction may include a set of one or more product identifiers corresponding to products purchased in the related payment transaction. In step 404, the processing unit 204 of the processing server 106 may identify one or more regular orders for the consumer 102. Each regular order may be for a set of product identifiers based on a frequency of that set of product identifiers as the set of one or more product identifiers included in the plurality of transaction data entries in the account profile 214. In some embodiments, the regular order may be based on the frequency of the respective set at a specific time and/or date or range thereof.

In step 406, the receiving unit 202 of the processing server 106 may receive a geolocation of the mobile communication device 108. In step 408, the processing unit 204 may determine if the consumer 102 is at a merchant 104 based on their geolocation. The determination may be made based on the identification of a merchant profile 210 in the merchant database 208 of the processing server 106 that includes a merchant geolocation that includes, is encompassed by, and/or is within a predetermined distance of the received geolocation. If no such merchant profile 210 is identified, it may be determined that the consumer 102 is not at a merchant 104, and the process 400 may end.

If the consumer 102 is at a merchant 104, then, in step 410, the processing unit 204 may identify if there is a regular order for the merchant 104 where the consumer 102 is located. The regular order may be for the specific merchant 104 or may be for a merchant industry associated with the merchant 104. If no regular order is identified, then the process 400 may end. If a regular order is identified, then, in step 412, the processing unit 204 may determine if the current time and/or date is within the time and/or date associated with the identified regular order. If the current time and/or date is outside of the regular order's time and/or date, then the process 400 may end.

If the current time and/or date is within the regular order's time and/or date, or if the regular order is not associated with a time and/or date, then, in step 414, the transmitting unit 206 of the processing server 106 may transmit the identified regular order to the mobile communication device 108 for confirmation from the consumer 102. In step 416, the receiving unit 202 may receive the response from the consumer 102 via the mobile communication device 108.

In step 418, the processing unit 204 may determine if the consumer 102 has confirmed that they desire their regular order or if they do not want their regular order. If the consumer 102 does not want their regular order, then the process 400 may be completed. If the consumer 102 does want their regular order, then, in step 420, the transmitting unit 206 may transmit the regular order to the merchant 104 for initiation of a payment transaction for the regular order. In some embodiments, the regular order may be accompanied by payment details, such as included in the consumer response, stored in the account profile 214, and/or indicated in the consumer response or account profile 214 for use in identification of payment details by the merchant 104.

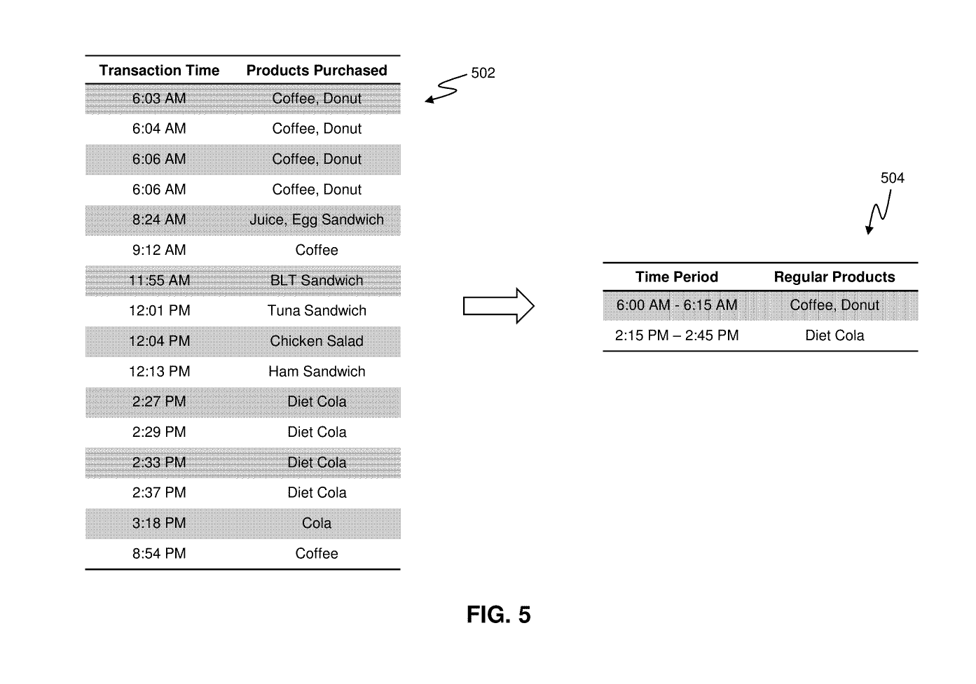

FIG. 5 illustrates the identification of regular orders for a consumer 102 at a merchant 104 using the methods and systems discussed herein, such as occurring during step 404 of the process 400 illustrated in FIG. 4 and discussed above.

FIG. 5 includes a table 502, which includes a plurality of transaction data entries. Each transaction data entry includes a time and a set of product identifiers corresponding to products purchased in the respective transaction data entry. The processing unit 204 may analyze the sets of product identifiers included in each transaction data entry to identify one or more regular orders based on the frequency of each respective set and the associated times.

The table 504 includes two regular orders identified by the processing unit 204 based on the transaction data included in the table 502. As illustrated in the table 504, the processing unit 204 may identify two regular orders based on the transaction data. The first regular order may be for a coffee and donut between 6:00 AM and 6:15 AM. The second regular order may be for a diet cola between 2:15 PM and 2:45 PM. A regular order is not identified during the 11:55 AM and 12:15 PM range due to the differences in the products purchased, as there is no purchase that is made more frequently than others. Similarly, a regular order is not identified during the other ranges, such as the 6:15 AM to 11:55 AM range, due to the lack of repeated transactions during the range.

### Exemplary Method for Identifying and Initiating a Regular Transaction

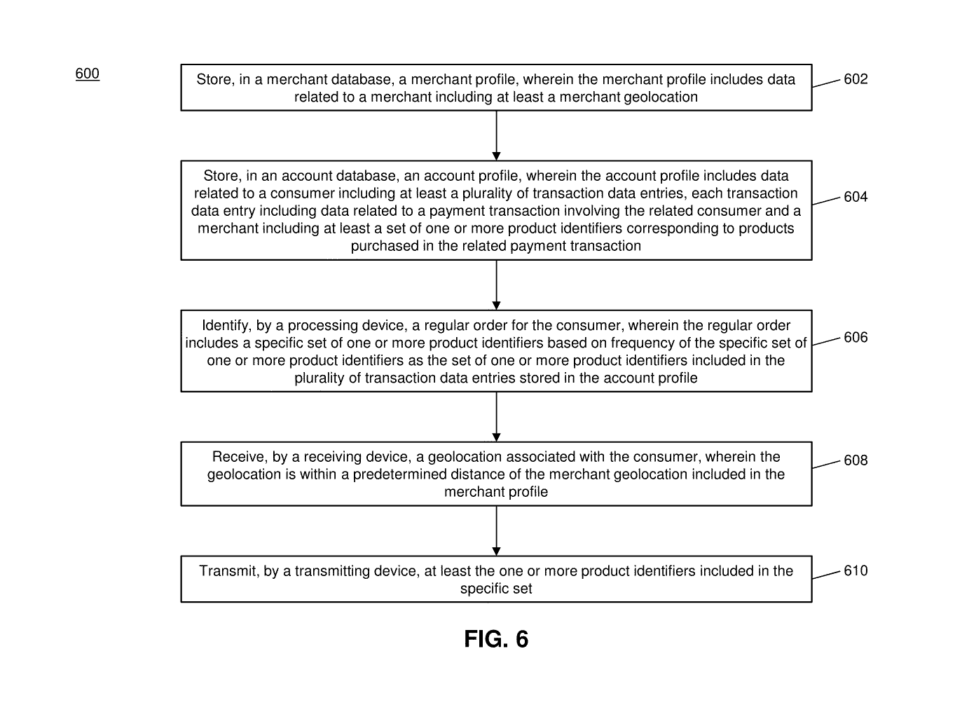

FIG. 6 illustrates a method 600 for identifying and initiating a regular transaction for a consumer based on purchase history.

In step 602, a merchant profile (e.g., merchant profile 210) may be stored in a merchant database (e.g., the merchant database 208), wherein the merchant profile 210 includes data related to a merchant (e.g., the merchant 104) including at least a merchant geolocation. In step 604, an account profile (e.g., account profile 214) may be stored in an account database (e.g., the account database 212), wherein the account profile 214 includes data related to a consumer (e.g., the consumer 102) including at least a plurality of transaction data entries, each transaction data entry including data related to a payment transaction involving the related consumer 102 and a merchant including at least a set of one or more product identifiers corresponding to products purchased in the related payment transaction. In one embodiment, each transaction data entry may be related to payment transaction involving a merchant among a plurality of merchants associated with a specific merchant category, and the merchant 104 related to the merchant profile 210 may be associated with the specific merchant category. In a further embodiment, the merchant 104 related to the merchant profile 210 may not be included in the plurality of merchants.

In step 606, a regular order for the consumer 102 may be identified by a processing device (e.g., the processing unit 204), wherein the regular order includes a specific set of one or more product identifiers based on frequency of the specific set of one or more product identifiers as the set of one or more product identifiers included in the plurality of transaction data entries stored in the account profile 214. In step 608, a geolocation associated with the consumer 102 may be received by a receiving device (e.g., the receiving unit 202), wherein the geolocation is within a predetermined distance of the merchant geolocation included in the merchant profile 210.

In step 610, at least the one or more product identifiers included in the specific set may be transmitted by a transmitting device (e.g., the transmitting unit 206). In some embodiments, the transmission may be to the merchant 104 for the initiation of a payment transaction for the one or more product identifiers. In a further embodiment, the account profile 214 may include payment details, and the transmission to the merchant 104 may include the payment details for use in funding the payment transaction for the one or more product

In one embodiment, each transaction data entry may further include a transaction time and/or date and the transaction time and/or date included in transaction data entries in the plurality of transaction data entries that include the specific set of one or more product identifiers may be within a predetermined period of time. In a further embodiment, the geolocation associated with the consumer 102 may be within a location time and/or date at which the geolocation was identified, and the location time and/or date may be within the predetermined period of time. In another further embodiment, the method 600 may also include identifying, by the processing device, a set of one or more product identifiers, wherein the transaction time and/or date included in transaction data entries in the plurality of transaction data entries that include the second set of one or more product identifiers are within a second period of time, and the one or more product identifiers included in the second set are transmitted instead of the one or more product identifiers included in the specific set if the geolocation associated with the consumer 102 is identified at a location time and/or date within the second period of time.

In some embodiments, the transmitting may be to a mobile communication device (e.g., the mobile communication device 108) and the method 600 may also include: receiving, by the receiving unit 202, a confirmation from the mobile communication device 108 indicating approval for the initiation of a transaction; and transmitting, by the transmitting device 206, at least one or more product identifiers included in the specific set to the merchant 104 initiation of a payment transaction for the one or more product identifiers. In a further embodiment, the account profile 214 may include payment details, and the transmission to the merchant 104 may include the payment details for use in funding the payment transaction for the one or more product identifiers.

### Computer System Architecture

FIG. 7 illustrates a computer system 700 in which embodiments of the present disclosure, or portions thereof, may be implemented as computer-readable code. For example, the processing server 106 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 4, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying and initiating a regular transaction for a consumer. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying and initiating a regular transaction for a consumer, comprising:
storing, in a merchant database, a merchant profile, wherein the merchant profile includes data related to a merchant including at least a merchant geolocation;
storing, in an account database, an account profile, wherein the account profile includes data related to a consumer including at least a plurality of transaction data entries, each transaction data entry including data related to a payment transaction involving the related consumer and a merchant including at least a set of one or more product identifiers corresponding to products purchased in the related payment transaction;
identifying, by a processing device, a regular order for the consumer, wherein the regular order includes a specific set of one or more product identifiers based on frequency of the specific set of one or more product identifiers as the set of one or more product identifiers included in the plurality of transaction data entries stored in the account profile;
receiving, by a receiving device, a geolocation associated with the consumer, wherein the geolocation is within a predetermined distance of the merchant geolocation included in the merchant profile; and
transmitting, by a transmitting device, at least the one or more product identifiers included in the specific set.

2. The method of claim 1, wherein the at least one or more product identifiers included in the specific set are transmitted in a request to initiate a transaction to a mobile communication device associated with the consumer, and the method further comprises:
receiving, by the receiving device, a confirmation from the mobile communication device indicating approval for the initiation of a transaction; and
transmitting, by the transmitting device, at least one or more product identifiers included in the specific set to the merchant for initiation of a payment transaction for the one or more product identifiers.

3. The method of claim 2, wherein
the account profile further includes payment details, and
transmitting the one or more product identifiers included in the specific set includes transmitting the payment details included in the account profile to the merchant for use in funding the payment transaction for the one or more product identifiers.

4. The method of claim 1, wherein the at least one or more product identifiers included in the specific set are transmitted to the merchant for initiation of a payment transaction for the one or more product identifiers.

5. The method of claim 4, wherein
the account profile further includes payment details, and
transmitting the one or more product identifiers included in the specific set includes transmitting the payment details included in the account profile to the merchant for use in funding the payment transaction for the one or more product identifiers.

6. The method of claim 1, wherein
each transaction data entry further includes a transaction time and/or date, and
the transaction time and/or date included in transaction data entries in the plurality of transaction data entries that include the specific set of one or more product identifiers are within a predetermined period of time.

7. The method of claim 6, wherein
the geolocation associated with the consumer is associated with a location time and/or date at which the geolocation was identified, and
the location time and/or date is within the predetermined period of time.

8. The method of claim 6, further comprising:
identifying, by the processing device, a second set of one or more product identifiers, wherein
the transaction time and/or date included in transaction data entries in the plurality of transaction data entries that include the second set of one or more product identifiers are within a second period of time, and
the one or more product identifiers included in the second set are transmitted instead of the one or more product identifiers included in the specific set if the geolocation associated with the consumer is identified at a location time and/or date within the second period of time.

9. The method of claim 1, wherein
each transaction data entry is related to a payment transaction involving a merchant among a plurality of merchants associated with a specific merchant category, and
the merchant related to the merchant profile is associated with the specific merchant category.

10. The method of claim 9, wherein the merchant related to the merchant profile is not included in the plurality of merchants.

11. A system for identifying and initiating a regular transaction for a consumer, comprising:
a merchant database configured to store a merchant profile, wherein the merchant profile includes data related to a merchant including at least a merchant geolocation;
an account database configured to store an account profile, wherein the account profile includes data related to a consumer including at least a plurality of transaction data entries, each transaction data entry including data related to a payment transaction involving the related consumer and a merchant including at least a set of one or more product identifiers corresponding to products purchased in the related payment transaction;
a processing device configured to identify a regular order for the consumer, wherein the regular order includes a specific set of one or more product identifiers based on frequency of the specific set of one or more product identifiers as the set of one or more product identifiers included in the plurality of transaction data entries stored in the account profile;
a receiving device configured to receive a geolocation associated with the consumer, wherein the geolocation is within a predetermined distance of the merchant geolocation included in the merchant profile; and
a transmitting device configured to transmit at least the one or more product identifiers included in the specific set.

12. The system of claim 11, wherein
the at least one or more product identifiers included in the specific set are transmitted in a request to initiate a transaction to a mobile communication device associated with the consumer,
the receiving device is further configured to receive a confirmation from the mobile communication device indicating approval for the initiation of a transaction; and
the transmitting device is further configured to transmit at least one or more product identifiers included in the specific set to the merchant for initiation of a payment transaction for the one or more product identifiers.

13. The system of claim 12, wherein
the account profile further includes payment details, and
transmitting the one or more product identifiers included in the specific set includes transmitting the payment details included in the account profile to the merchant for use in funding the payment transaction for the one or more product identifiers.

14. The system of claim 11, wherein the at least one or more product identifiers included in the specific set are transmitted to the merchant for initiation of a payment transaction for the one or more product identifiers.

15. The system of claim 14, wherein
the account profile further includes payment details, and
transmitting the one or more product identifiers included in the specific set includes transmitting the payment details included in the account profile to the merchant for use in funding the payment transaction for the one or more product identifiers.

16. The system of claim 11, wherein
each transaction data entry further includes a transaction time and/or date, and
the transaction time and/or date included in transaction data entries in the plurality of transaction data entries that include the specific set of one or more product identifiers are within a predetermined period of time.

17. The system of claim 16, wherein
the geolocation associated with the consumer is associated with a location time and/or date at which the geolocation was identified, and
the location time and/or date is within the predetermined period of time.

18. The system of claim 16, wherein
the processing device is further configured to identify a second set of one or more product identifiers,
the transaction time and/or date included in transaction data entries in the plurality of transaction data entries that include the second set of one or more product identifiers are within a second period of time, and
the one or more product identifiers included in the second set are transmitted instead of the one or more product identifiers included in the specific set if the geolocation associated with the consumer is identified at a location time and/or date within the second period of time.

19. The system of claim 11, wherein
each transaction data entry is related to a payment transaction involving a merchant among a plurality of merchants associated with a specific merchant category, and
the merchant related to the merchant profile is associated with the specific merchant category.

20. The system of claim 19, wherein the merchant related to the merchant profile is not included in the plurality of merchants.
